(19) United States
(12) Patent Application Publication
(10) Pub. No.: US 2006/0130034 A1
(43) Pub. Date: Jun. 15, 2006

(54) Apparatus, system, and method for providing access to a set of resources available directly to a particular class loader

(76) Inventors: Michael Beisiegel, Poughkeepsie, NY (US); Stephen Andrew Brodsky, Los Gatos, CA (US); Jean-Sebastien Michael Delfino, San Carlos, CA (US); Zhaohui Feng, Fremont, CA (US)

Correspondence Address: KUNZLER & ASSOCIATES, 8 EAST BROADWAY, SUITE 600, SALT LAKE CITY, UT, 84111, US

(21) Appl. No.: 11/014,106

(22) Filed: Dec. 15, 2004

(51) Int. Cl. G06F 9/44

(52) U.S. Cl. 717/166

(57) ABSTRACT

An apparatus, system, and method are disclosed for providing access to a set of resources available directly to a particular class loader. The apparatus includes a request handler, a locator, an association module, and a navigation module. The request handler receives a resource identifier. The locator identifies a local resource set comprising resources available directly to a particular class loader. The resources correspond to the resource identifier. The association module associates the local resource set with the particular class loader. The navigation module locates a first resource accessible to a particular class loader based on a resource location policy. The resource location policy determines a search order of a class loader hierarchy to locate the first resource among local resource sets identified for each class loader in the class loader hierarchy. The apparatus provides access to, and navigation among, local resources of class loaders in a dynamic resource loading environment.

### BACKGROUND OF THE INVENTION

1. Field of the Invention

This invention relates to a Java software environment that uses class loaders to dynamically load classes and more particularly relates to providing access to a set of resources available directly to a particular class loader.

2. Description of the Related Art

The Java programming language continues to grow in popularity and use in object-oriented software systems. Advantageously, Java loads classes dynamically on an “as-needed” basis at runtime from external resources such as files including metadata files and class files. Consequently, Java applications can be readily updated and modified rapidly, in some cases even during runtime.

In current versions of the Java programming language, including Java Version 2 Standard Edition (J2SE) and Java Version 2 Enterprise Edition (J2EE), a hierarchical class loader architecture is used to load classes. The class loader architecture permits developers through an Application Programming Interface (API) to use particular class loaders of the hierarchy to load specific classes accessible to the particular class loader.

However, if a class is not found by the class loader called in a class load request, the class load request is delegated up the hierarchy to a parent class of the class loader called. The Java language does not permit a class load request to be delegated from a parent class loader to its child class loader. The process of determining how the request is delegated to a called class loader and to parent class loaders is referred to as a delegation model.

The default behavior for the delegation model is to search for the class first within classes visible or accessible to the parent of the called class loader and if unsuccessful, delegate the class load request to the called class loader. Each successive parent class loader up the class loader hierarchy delegates the request to a parent class loader until the root class loader is reached. Then, each class loader from the root class loader down attempts to find the class until the class is successfully loaded. An error occurs if no class loader finds the class.

The class loader hierarchy and delegation model are also used to locate and load resources. A resource is any data that can be accessed by a class independent of the location of the executing class. Typically, resources comprise metadata and datasets used by a class. Resources can be organized into files with a format such as an eXtensible Markup Language (XML). Examples of some resources include images, audio files, video files, text files, and the like.

FIG. 1 illustrates different levels of Java classes in which visibility of Resources A-D is determined by the class loader hierarchy, the delegation model, and the standard Java API published for the language. The innermost circle represents a logical root class loader, ClassLoader 1, in the class loader hierarchy. ClassLoader 1 is the logical root class loader from the perspective of the developer and could include a set of core class loaders such as a Java Development Kit (JDK) Application ClassLoader, a JDK Exension ClassLoader, and a JDK Bootstrap ClassLoader. Those of skill in the art will recognize that the JDK class loaders exist and may form a logical root class loader, ClassLoader 1.

The next three concentric circles, moving out from the ClassLoader 1, represent successive hierarchical levels descendent from the logical root class loader and could include ClassLoader 2, such as a server extension class loader, an application class loader, and a component/module class loader respectively.

Resources A-D are of the same type and format and have the same name, “Resource” (letters A-D are illustrated for convenience). Each Resource A-D is directly visible or accessible to a single class loader. For example, ClassLoader 1 can only directly access Resource C. Using the default delegation model, a request made to ClassLoader 4 is passed up to ClassLoader 3 and then cascaded down until a resource, Resource A, is found and loaded. Consequently, a request to ClassLoader 3 for a resource also returns Resource A.

It is often desirable to load resources based on a particular loading scheme, methodology, or model. For example, Resource A, which is higher in the loading hierarchy, can be used to declare default settings which can be overridden by Resources B-D. A developer may use the current Java API to load Resource A or to load all the resources (Resources A-C) from the called class loader up the hierarchy and merge them together for an overall resource such as configuration settings for an application.

Unfortunately, the Java API does not permit a developer to load just resources directly or locally visible to a specific class loader, also referred to as “local resources”. As used herein, the term “local resources” refers to resources that are directly visible or accessible to a specific class loader. Resources accessible or visible by way of another class loader in the hierarchy and/or using a delegation model are not directly visible or accessible and are therefore not “local resources.” In FIG. 1, Resource B is a local resource for ClassLoader 2.

Suppose a developer attempts to load Resource B using ClassLoader 3. The result, using the Java API, is that Resource A or Resources A-C are found. The developer then has to use some other mechanism to distinguish between Resources A-C in order to locate Resource B. For example, the resources may be deployed such that a Uniform Resource Locator (URL) associated with each resource will uniquely identify Resource B. This is problematic because the developer is relying on deployment strategies in order to locate and use local resources for a class loader. The runtime deployment locations of resources could differ from that expected in the executing developer code.

Furthermore, suppose a developer desires to control how resources are loaded. For example, a developer desires an application configuration setting to determine whether a local resource, Resource B, of the ClassLoader 2 is loaded before a local resource, Resource C, of the application level, ClassLoader 3. The conventional Java API does not support the ability to control which resource, Resource B or Resource C, is loaded or the order in which the Resources B-C are loaded.

From the foregoing discussion, it should be apparent that a need exists for an apparatus, system, and method for providing access to a set of resources available directly to a particular class loader. Beneficially, such an apparatus, system, and method would allow a developer to identify and associate local resources of a class loader with each class loader in a class loader hierarchy. Additionally, the apparatus, system, and method would allow a developer to control how local resources associated with the class loaders are located and/or loaded. In this manner, the developer has a finer level of control of identification and loading of resources such that a variety of resource contribution/delegation models can be readily implemented.

### SUMMARY OF THE INVENTION

The present invention has been developed in response to the present state of the art, and in particular, in response to the problems and needs in the art that have not yet been fully solved by currently available APIs. Accordingly, the present invention has been developed to provide an apparatus, system, and method for providing access to a set of resources available directly to a particular class loader that overcomes many or all of the above-discussed shortcomings in the art.

The apparatus to provide access to a set of resources available directly to a particular class loader includes a plurality of modules. These modules in the described embodiments include a request handler, a locator, and an association module.

The request handler receives a resource identifier. The request handler may also receive a class loader. Alternatively, the request handler derives the class loader from the context of a request. The request may comprise a request for a local resource of a specific class loader, the resource identifier comprising a name of the desired local resource. The request handler may receive the request through an API made available to the developer.

The locator identifies a local resource set comprising resources available directly to a particular class loader. The resources have a name that corresponds to the resource identifier. The locator may include a searcher and a comparison module. The searcher determines a first intermediate set comprising one or more resources accessible both to the particular class loader and to ancestors of the class loader. The searcher may be further configured to determine a second intermediate set comprising one or more resources accessible both to a parent class loader of the particular class loader and to ancestors of the parent class loader. The resources of the first intermediate set and the second intermediate set correspond to the resource identifier. The comparison module removes members of the second intermediate set found in the first intermediate set to define a local resource set for the particular class loader.

The association module associates the local resource set with the particular class loader. The association module may include a population module and a registration module. The population module may populate a resource construct with the resource identifier, the particular class loader, and a resource location for each member of the local resource set. The registration module may register each resource construct in a repository. Each entry in the repository may include a key comprising a class loader and a resource identifier.

The apparatus may optionally include a navigation module configured to locate a first resource accessible to the particular class loader based on a resource location policy. The resource location policy may determine a search order of a class loader hierarchy to locate the first resource among local resource sets identified for each class loader in the class loader hierarchy. The resource location policy may be provided by a configuration setting for the particular class loader or by a software call from developer source code. The navigation module may be further configured to locate a second resource accessible to the particular class loader based on a relative resource location policy. The relative resource location policy may cause the navigation module to search for the second resource in the same location as the first resource.

The apparatus may include of a predefined second local resource set comprising resources accessible to a second class loader and not to ancestors of the second class loader. In addition the apparatus may include a traversal module configured to designate a parent class loader of the particular class loader as the particular class loader and repeatedly call the locator and association module until a local resource set is defined for a root class loader. A hierarchy module may define a hierarchical data structure comprising the local resource set and the second local resource set in substantially the same hierarchical relationship as the particular class loader and the second class loader. An optional storage module may preserve an association of the local resource set to the particular class loader.

A system of the present invention is also presented for providing access to a set of resources available directly to a particular class loader, “local resources”. The system includes modules substantially similar to those described above in relation to different embodiments of the apparatus. In addition, the system includes a repository comprising a plurality of dynamically loadable resources. A plurality of class loaders in the system may be organized into a hierarchical relationship. A resource location module within a utility module of the system may include a request handler, locator, and association module substantially similar to like-named modules of the apparatus described above.

A method is also presented for providing access to a set of resources available directly to a particular class loader. The method in the disclosed embodiments substantially includes the steps necessary to carry out the functions presented above with respect to the operation of the described apparatus and system. In one embodiment, the method includes an operation to receive a resource identifier, an operation to identify a local resource set comprising resources available directly to a particular class loader, the resources corresponding to the resource identifier, and an operation to associate the local resource set with the particular class loader. The method may also include an operation to locate a first resource accessible to a particular class loader based on a resource location policy. The resource location policy may determine a search order of a class loader hierarchy to locate the first resource among local resource sets identified for each class loader in the class loader hierarchy.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. One skilled in the relevant art will recognize that references to a software object may refer to an instance of the object or an identifier for the object including a name or other pointer.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a concept diagram illustrating relationships of resources to class loaders in a class loader hierarchy;

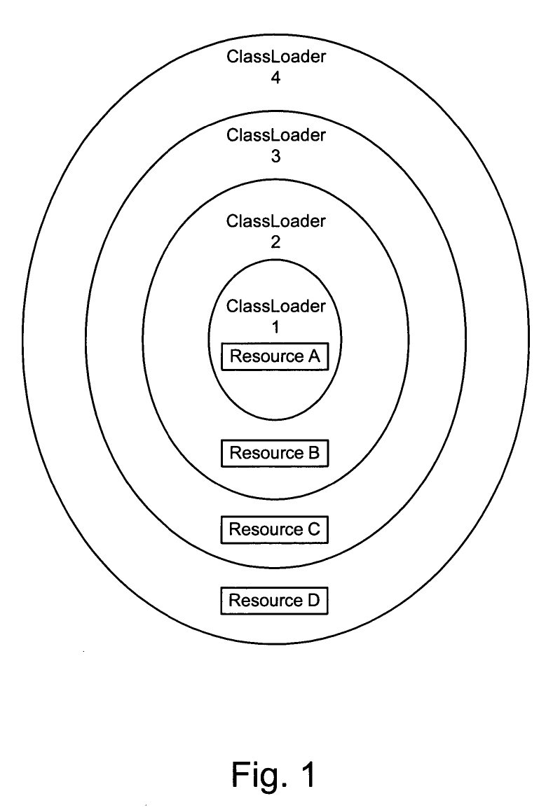

FIG. 2 is a schematic block diagram illustrating one embodiment of an system for providing access to a set of resources available directly to a particular class loader;

FIG. 3 is a schematic block diagram illustrating one embodiment of an apparatus for providing access to a set of resources available directly to a particular class loader;

FIG. 4 is a schematic block diagram illustrating a class loader hierarchy and a relationship between class loaders and local resources made accessible by one embodiment of an apparatus for providing access to a set of resources available directly to a particular class loader;

FIG. 5 is a schematic block diagram illustrating one embodiment of an apparatus for providing access to a set of resources available directly to a particular class loader; and

FIG. 6 is a schematic flow chart diagram illustrating one embodiment of a method for providing access to a set of resources available directly to a particular class loader.

### DETAILED DESCRIPTION OF THE INVENTION

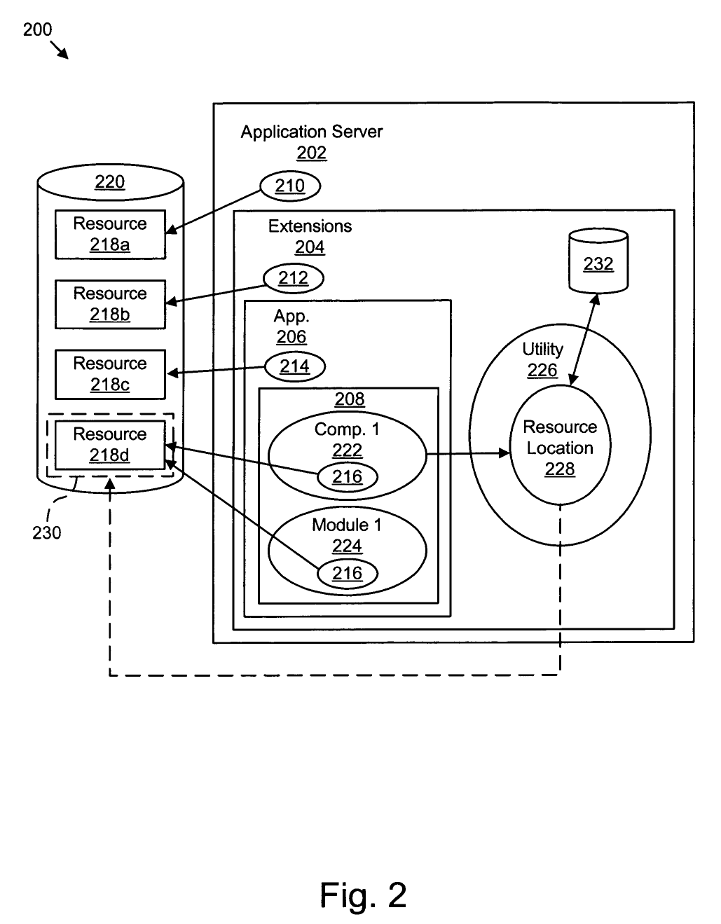

FIG. 2 illustrates a system 200 for providing access to a set of resources available directly to a particular class loader. The system 200 includes hierarchical operating environments similar to those provided in J2SE and J2EE. Specifically, the system 200 provides an application server level 202, an extensions level 204, an application level 206, and a component/module level 208. The application server level 202 may be implemented by an application server such as a Websphere Application Server (WAS) available from IBM.

Typically, each level 202, 204, 206, 208 includes a class loader 210, 212, 214, 216 organized in a hierarchical relationship (also referred to herein as a class loader hierarchy) substantially similar to that of the operating environment levels 202, 204, 206, 208. (Software units within an operating environment level 202, 204, 206, 208 are illustrated with ovals.) Preferably, the hierarchical relationship allows a parent class loader such as the application server class loader 210 to have multiple child class loaders such as extensions class loaders 212. But, child class loaders are permitted to have just one parent class loader. Each child generation is capable of accessing more dynamically loadable resources than an immediate parent generation.

The hierarchical relationship among operating environment levels 202, 204, 206, 208 implemented by class loaders allows a developer writing source code at the application level 206 or module/component level 208 to access functionality built into the higher levels 202, 204, 206 dynamically at runtime through published APIs. The Java runtime environment loads the called functionality, typically embodied as an object defined by a class, on-demand and unloads the functionality when an object is no longer in use.

Developers use the same APIs, hierarchy, and class loaders 210, 212, 214, 216 to access resources other than classes. Each class loader in the class loader hierarchy includes an environment variable (referred to herein as a CLASSPATH) defining where the class loader will search to attempt to load a particular class or resource. Generally, all class files or resources within the location identified by the CLASSPATH (and possibly any sub-directories) are visible or accessible to the class loader. Typically, the CLASSPATH is a path in a file system but could also include other forms of identifiers including a Uniform Resource Identifier (URI). The class or resource is identified by a resource identifier such as a name.

Typically, the class loader searches the files, directories, and sub-directories listed in the CLASSPATH. The class loader also searches for the class or resource within archive files including Java Archive (JAR), Web component Archive (WAR), and Enterprise Archive (EAR) files. If the class loader finds a class or resource having the same name as the resource identifier provided in the request, that class or resource is loaded and/or returned. If more than one class or resource is found within the CLASSPATH, the name conflict is resolved but the conventional Java API does not indicate to a developer which class or resource was selected.

Typically, the system 200 stores resources 218a-d in a common repository 220. Of course, the resources 218a-d may also be distributed among multiple storage entities and/or computer systems interconnected by a network. As discussed above, a developer may desire to control which resources 218a-d are loaded and/or the order in which resources are loaded. Certain tools written in APIs at the extensions level 204 may allow a developer to change the standard Java delegation model, described above programmatically. Specifically, the developer may designate, in an API call of a component 222 or module 224, whether classes or resources 218a-d visible to a parent class loader 214 are loaded before classes or resources 218a-d visible to a child class loader 216 and vice versa.

Advantageously, the system 200 includes, within a utility module 226, a resource location module 228 that permits a developer to access a set of resources available directly to a specific class loader. The utility module 226 may comprise a tool set provided in the extensions level 204. Of course the resource location module 228 may operate within the application server level 202 or an application level 206 as well. Alternatively, the resource location module 228 may operate as an independent module 224. Preferably, the resource location module 228 is a utility level module with a well defined API available to developers.

The resource location module 228 receives a resource identifier and an identifier of(or an instance of) a specific class loader 210, 212, 214, 216. With these inputs, the resource location module 228 identifies a set of resources 230 available directly to the specific class loader. Each resources 218 in the set of resources 230 has a name corresponding to the resource identifier. This set of resources 230 is referred to herein as local resources 230 for the specific class loader. Local resources 230 are resources 218 accessible or available only to the specific class loader and not indirectly through use of a parent class loader.

For example, suppose an API call in a component 222 requests local resources 230 for class loader 216. The resource location module 228 identifies resource 218d in the repository as a single local resource 230. In addition, the resource location module 228 preferably associates the set of local resources 230 with the specific class loader 216 on-demand and dynamically. The association may be retained within a repository 232 configured for this purpose. The repository 232 may comprise a map, an array or other non-persistent or persistent structure for storing the association. In this manner, the resource location module 228 can satisfy a subsequent request for local resources 230 of the class loader 216 with the same resource identifier by referencing the association in the repository 232.

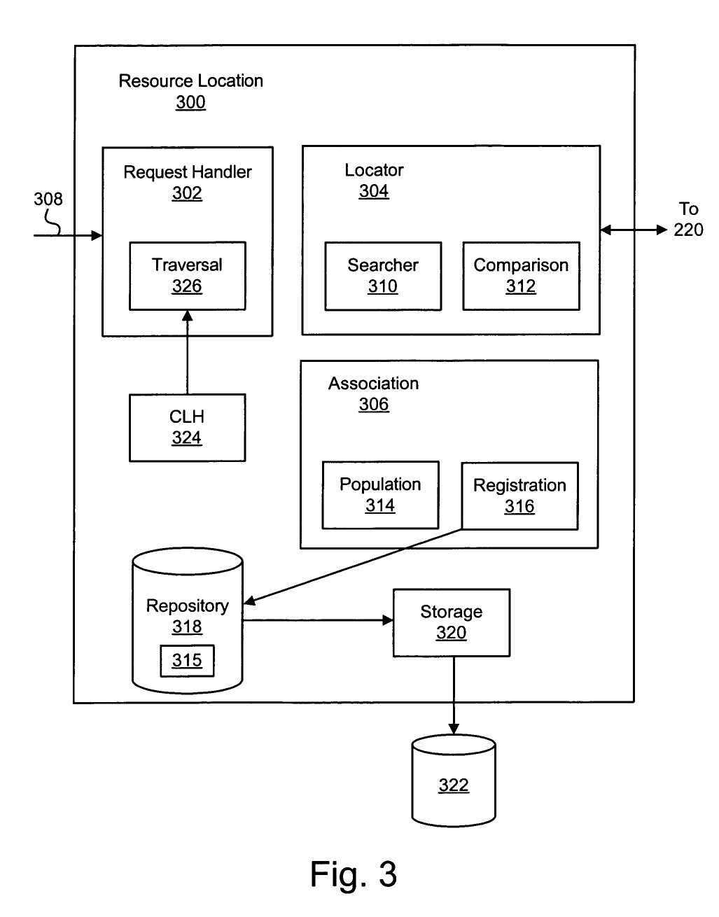

FIG. 3 illustrates an apparatus for providing access to a set of resources available directly to a particular class loader. The apparatus comprises a resource location module 300 substantially similar in functionality to the resource location module 228 described in relation to FIG. 2. The resource location module 300 includes a request handler 302, a locator 304, and optionally an association module 306.

The request handler 302 accepts or receives a request 308. The request may include a resource identifier. Typically, the resource identifier is a name of the resource the developer desires to identify in relation to a particular class loader. In certain embodiments, the request handler 302 derives the particular class loader from the request 308 or from the context of the call that issues the request 308.

The locator 304 identifies local resources 230 for the particular class loader and resource identifier. The locator 304 may include a searcher 310 and a comparison module 312. The searcher 310 determines two intermediate sets. A first intermediate set includes resources 218a-d accessible both to the particular class loader and to ancestors of the class loader in the class loader hierarchy. The searcher 310 finds all resources 218a-d matching the resource identifier that the particular class loader can access as well as those its ancestors can access. The second intermediate set include resources accessible both to a parent class loader of the particular class loader and to ancestors of the parent class loader in the class loader hierarchy. The search process for the second intermediate set is similar but starts with the parent of the particular class loader. In performing the searches, the searcher 310 may reference a resource repository 220.

Referring for a moment back to FIG. 2, if the particular class loader is a component class loader 216 and the resource identifier is “Resource,” the first intermediate set would include four resources, resources 218a-d. The second intermediate set would include three resources, resources 218a-c, because resource 218d is not accessible by class loader 214, the parent of class loader 216.

Referring back to FIG. 3, the comparison module 312 compares the first intermediate set to the second intermediate set to determine the local resource set 230. Specifically, the comparison module 312 removes members of the second intermediate set that are also found in the first intermediate set. In certain embodiments, the comparison module 312 may perform a set difference operation on the first intermediate set and the second intermediate set such that the resulting resource set 230 includes resources in the first intermediate set that are not in the second intermediate set.

In the example above in relation to FIG. 2, the resource set 230 provided by the comparison module 312 includes just resource 218d because this is the resource accessible directly by the class loader 216. “Direct access” as used herein means that the class loader 216 accesses the resources 218a-d without enlisting other class loaders in the class loader hierarchy.

Referring again to FIG. 3, an optional association module 306 of the resource location module 300 associates the set of local resources 230 with the particular class loader and resource identifier. In one embodiment, the association module 306 includes an optional population module 314 and a registration module 316.

The population module 314 may populate a resource construct 315, also referred to as a resource object 315, with relevant information determined by the locator 304. In one embodiment, the population module 314 sets attributes of a new resource object 315 with information such as the resource identifier, the particular resource loader (or an identifier therefore), and a resource location. The population module 314 may create a separate resource object 315 for each resource within the set of local resources 230. Preferably, the resource location comprises a URI or a URL. The resource location may also be a URL object.

The registration module 316 registers each resource object 315 in a repository 318. Resource objects 315 are identified in the repository 318 by a key comprised of the class loader (or a pointer to the class loader) and the resource identifier. In one embodiment, the key includes the URL for a resource object 315 such that local resources that each share the same name can be differentiated. The repository 318 may be substantially similar to the repository 232 described in relation to FIG. 2. In one embodiment, the repository 318 comprises a map object within the Java language.

The resource location module 300 may include a storage module 320 configured to preserve or store resource objects 315 in the repository 318 in persistent storage 322 such as a database, file system, or other storage system. The storage module 320 may operate independently and automatically to store newly added resource objects 315 periodically. Alternatively, the storage module 320 operates in response to a request from a developer through the API.

Preferably, the resource location module 300 responds to a variety of different types of requests 308, in addition to the type described above. One request 308 may request identification and association of all local resources 230 for class loaders of a class loader hierarchy (CLH) 324 given a resource identifier and a starting class loader. The CLH 324 may comprise a logical construct or a hierarchical data structure such as a tree or graph that reflects the hierarchical relationship between class loaders.

The request handler 302 may route such a request 308 to a traversal module 326. The traversal module 326 may call the locator 304 and the association module 306 with the starting class loader and resource identifier. Once the locator 304 and association module 306 finish, the traversal module 326 may designate a parent class loader of the starting class loader and call the locator 304 and the association module 306 again. The traversal module 326 may repeatedly call the locator 304 and association module 306 with parent class loaders until a local resource set 230 is defined class loaders between the starting class loader and a root class loader.

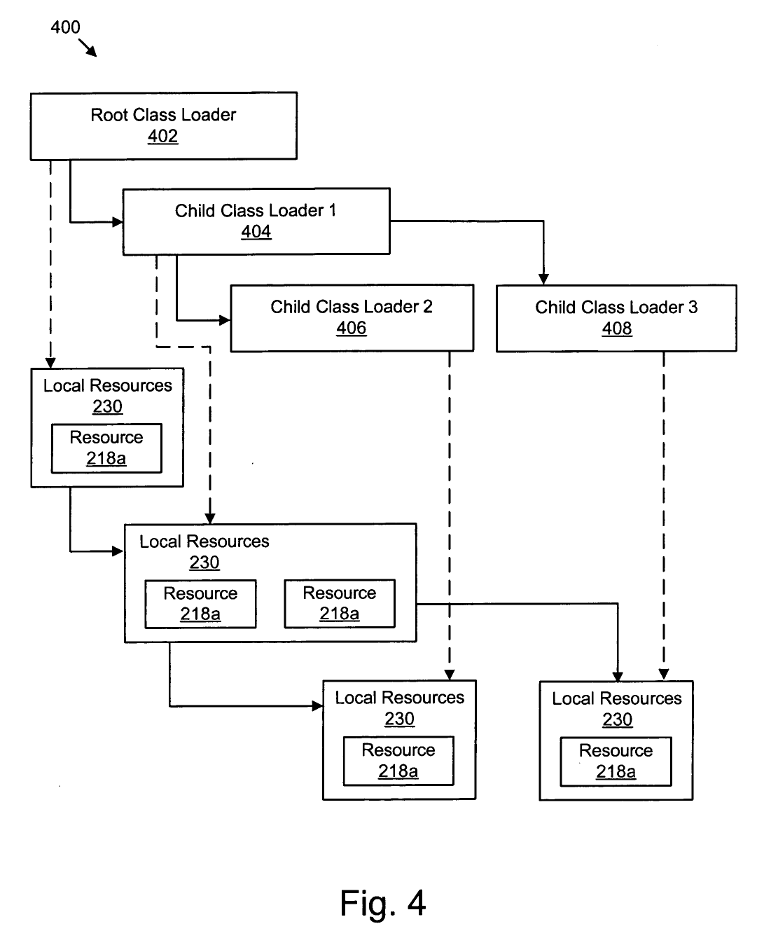

FIG. 4 illustrates a logical representation of a class loader hierarchy 400. The class loader hierarchy 400 typically corresponds to the class loader hierarchy 324 described in relation to FIG. 3 and to the operating environment level hierarchy 202, 204, 206, 208 discussed in relation to FIG. 2. A root class loader 402 is at the top of the hierarchy 400. One or more descendent child class loaders 404, 406, 408 have a parent-child relationship with a higher class loader. The class loaders 402-408 cooperate using a delegation model to dynamically load executable code such as Java classes and resources as needed. It should be noted that one or more nodes of the hierarchy 400 may include multiple child class loaders. For example, class loader one 404 may include child class loader two 406 and child class loader three 408.

In one embodiment, the class loader hierarchy 400 corresponds to a runtime class loader hierarchy in J2EE. Specifically, the root class loader 402 may correspond to an application server class loader, the child class loader one 404 may correspond to an extensions class loader, and child class loader two 406 and child class loader three 408 may correspond to application class loaders.

The resource location module 300 permits access to local resources 230 (See FIG. 2) for each class loader in the hierarchy 400. The resource location module 300 also associates the local resources 230 with a particular class loader as indicated by the dashed arrows. Using these features, a developer can access or logically navigate a tree 410 or graph 410 of local resources 230 to locate and/or load particular resources 218a.

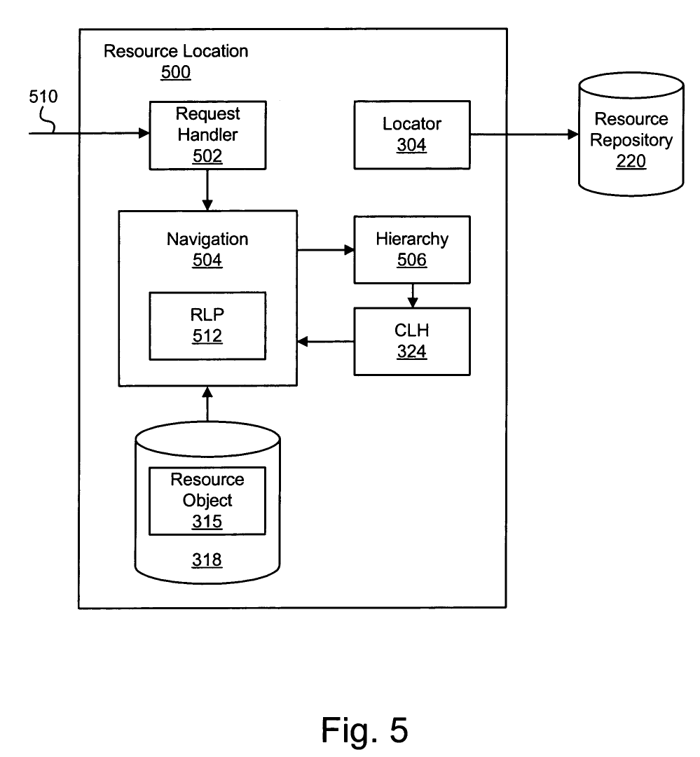

FIG. 5 illustrates one embodiment of a resource location module 500 that facilitates navigation of the tree 410. The resource location module 500 may include the features and functionality of resource location module 300 as well as navigation capabilities for identifying, accessing, and/or loading local resources 230. Consequently, like modules are similarly numbered in FIG. 5.

The resource location module 500 may include a request handler 502, navigation module 504, and hierarchy module 506. The request handler 502 may accept requests 308 as described in FIG. 3 as well as requests 510 configured to navigate class loader hierarchy 400 or local resource hierarchy 410 according to a resource location policy (RLP) 512.

The requests 510 may come in the form of API calls. One example API call maybe of the form: “ClassLoader.GetLocalResource(RLP, “Resource.xml”).” Those of skill in the art will recognize that the API call may take various forms. In particular, the resource name may be specified to form a resource set for which a GetLocalResource method may be defined. In this example, “ClassLoader” identifies a class loader object to start with in searching for resource 218a, “Resource.xml.” “GetLocalResource” is a name of the API function. And, “RLP” is a resource location policy, discussed in more detail below. Of course, other API calls may return a list of resources as well.

The navigation module 504 responds to requests 510 and locates one or more resources based on the RLP 512. In certain embodiments, the navigation module 504 cooperates with a hierarchy module 506 to build a class loader hierarchy (CLH) 324. The CLH 324 may comprise a hierarchical tree structure mirroring the class loader hierarchy 400. The navigation module 504 may use the CLH 324 to search for the resource 218a. Alternatively, the navigation module 504 use the class loader hierarchy 400 available logically within the runtime environment. In certain embodiments, the navigation module 504 may return the CLH 324 as part of a return value for the request 510.

Preferably, the navigation module 504 cooperates with the locator 304 to determine sets of local resources 230 as needed. Initially, the repository 318 may be empty. As requests 510 are made to access or navigate among sets of local resources 230 for particular class loaders, the locator 304 preferably registers the resources objects 315 identified as local resources 230 in the repository. Consequently, the navigation module 504 may first reference the repository for a set of local resources 230. If none are found, the navigation module 504 may signal the locator 304 to register whether there are any local resources 230 for a particular class loader and resource identifier.

In one embodiment, the RLP 512 is provided as part of a software call from developer source code. For example, an argument of an API call may include the RLP 512 using predefined constants. Alternatively, the RLP 512 may be predefined by a configuration setting for a particular class loader referenced by a developer.

The RLP 512 determines a search order for searching the class loader hierarchy 400 to locate a resource 218a. In particular, the RLP 512 allows a developer to control the delegation model of a search for local resources. In one embodiment, the navigation module 504 supports a PARENT_FIRST RLP 512, a PARENT_LAST RLP 512, a DEFAULT RLP 512, and a RELATIVE RLP 512.

The PARENT_FIRST RLP 512 causes the navigation module 504 to search for one or more matching resources 118a among local resources 230 of the parent class loader and ancestor class loaders of the particular class loader before searching among local resources 230 of the particular class loader. The search request is delegated up the hierarchy 400 to the root class loader 402. The searching begins at the root class loader 402 and cascades down the hierarchy 400. If one or more matching resources 118a are found in a parent or ancestor, the search stops and may return the corresponding resource objects 315. If no resources 118a are found, the search cascades down to a child class loader on the next level. The search proceeds to search among local resources 230 for the descendant class loader until the particular class loader is reached. If no ancestors of the particular class loader provide matching resources 118a, the search is conducted for local resources 230 for the particular class loader. Such a resource location policy may be useful to a developer desiring to use configuration settings of a configuration resource file provided by an environment level first such as application server level 202 (See FIG. 2) before resorting to configuration settings of configuration resource file local to an application level 206.

The PARENT_LAST RLP 512 is exactly the opposite search order of PARENT_FIRST RLP 512. The local resources 230 of the particular class loader are searched before searching local resources 230 of parent class loaders. In certain embodiments, the class loaders are configured independent of the developers' source code to implement a PARENT_FIRST or PARENT_LAST delegation model. Providing a PARENT_FIRST RLP 512 or PARENT_LAST RLP 512 overrides this setting. Providing a DEFAULT RLP 512 causes the navigation module 504 to search using the PARENT_FIRST or PARENT_LAST delegation model defined for each class loader. Consequently, search requests may recursively travel up the hierarchy and/or search certain specific levels depending on the delegation model setting for each node in the hierarchy. In this manner, the search becomes a combination of PARENT_FIRST and PARENT_LAST.

The RELATIVE RLP 512 requires that a first local resource 230 by found for a particular class loader. The RELATIVE RLP 512 then causes the navigation module 504 to locate a second local resource 230 relative to the location of the first local resource. This may mean that the navigation module 504 searches for the second local resource 230 in the same location as the first local resource was found.

A developer may use the RELATIVE RLP 512 to dynamically identify and load software modules including Java modules. The modules may or may not have interdependencies. By loading relative to software modules previously identified, the developer is able to properly locate all dependent software modules regardless of how the software modules are deployed in the runtime environment. Consequently, developers may use the present invention to dynamically locate and build software modules. In addition, the developer may dynamically create module class loaders having dependencies that correlate to the resource dependencies.

In this manner, using different types of RLPs 512, a developer can implement various different resource contribution models and/or delegation models. For example, the developer may place default configuration settings in a resource file visible to an application server level 202 which overrides configuration settings visible to the application level 206. Consequently, the developer may use the PARENT_FIRST RLP 512 to ensure that the local resource 230 visible to the application server level 202 is loaded instead of a resource file 118a local to the application level 206. In other instances, a local resource 230 may be used as a reference in loading other resources 218a. For example, a first local resource 230 may include pointers to other dependent resources. The developer may use the local resource 230 to identify or locate these dependent resources.

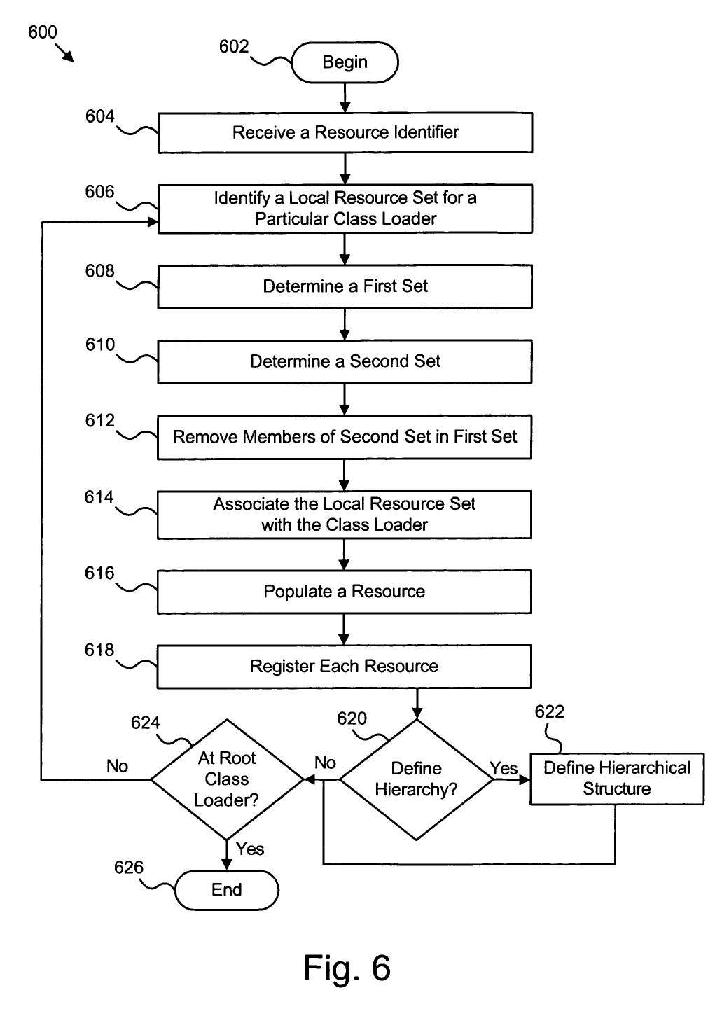

FIG. 6 illustrates a method 600 for providing access to a set of resources available directly to a particular class loader. The method 600 may be embodied as a set of machine-readable instructions. The method 600 may begin 602 when a developer makes a call to access a local resource 230 for a particular class loader.

Initially, the request handler 302, 502 receives 604 the resource identifier. Typically, the resource identifier is included in a request 308, 510. In addition, the request 308, 510 may identify the particular class loader involved.

If no local resources 230 for the class loader, resource identifier combination have been identified, the locator 304 identifies 606 a local resource set 230 for the particular class loader. Alternatively, the request handler 302 may reference pre-registered resource objects 315 in the repository 318 constituting the local resource set 230. A searcher 310 within the locator 304 may determine 608 a first set of resources accessible both to the particular class loader and to ancestors of the class loader. The searcher 310 may also determine 610 a second set of resources accessible both to a parent class loader of the particular class loader and to ancestors of the parent class loader.

Next, a comparison module 312 may remove members of the second set also found in the first set. The resulting set comprises a local resource set 230 for the particular class loader and the resource identifier. In certain embodiments, an association module 306 may associate 614 the local resource set 230 with the particular class loader. The association may be temporary. In one embodiment, the population module 314 populates 616 a resource object 315 that identifies the local resource 218a by name, class loader, and URL. Preferably, a resource object 315 is populated for each local resource 218a in the set of local resources 230. The registration module 316 may register 618 each resource 218a in a repository 318 such that subsequent requests for the local resource 218a can be more rapidly satisfied.

In certain embodiments, the request handler 302, 502 may determine 620 whether the request 308, 510 requires a hierarchical data structure such as a class loader hierarchy (CLH) 324. If so, the hierarchy module 506 defines 622 the CLH 324. The request handler 302, 502 may pass the CLH 324 back to a caller that sent the request 308, 510.

In one embodiment, the request 308, 510 may cause the resource location module 300 to identify and associate local resources 230 for all class loaders in a class loader hierarchy 400 beginning with the particular class loader and proceeding up the hierarchy to the root class loader 402. Consequently, the request handler 302 may determine 624 whether the root class loader 402 has been evaluated to identify local resources 230. If not, the method 600 proceeds to step 606 with the parent of the particular class loader now designated as the particular class loader. If so, the method 600 ends 626.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for providing access to a set of resources available directly to: a particular class loader, the apparatus comprising:
a request handler configured to receive a resource identifier;
a locator configured to identify a local resource set comprising resources available directly to a particular class loader, the resources corresponding to the resource identifier; and
an association module configured to associate the local resource set with the particular class loader.

2. The apparatus of claim 1, wherein the class loader is in a hierarchical relationship with one or more ancestor class loaders, and wherein the locator further comprises,
a searcher configured to determine a first intermediate set comprising one or more resources accessible both to the particular class loader and to ancestors of the class loader, the searcher further configured to determine a second intermediate set comprising one or more resources accessible both to a parent class loader of the particular class loader and to ancestors of the parent class loader, the resources of the first intermediate set and the second intermediate set corresponding to the resource identifier; and
a comparison module configured to remove members of the second intermediate set found in the first intermediate set to define the local resource set.

3. The apparatus of claim 1, wherein the association module further comprises,
a population module configured to populate a resource construct with the resource identifier, the particular class loader, and a resource location for each member of the local resource set; and
a registration module configured to register each resource construct in a repository, each entry in the repository having a key comprising a class loader and a resource identifier.

4. The apparatus of claim 1, further comprising a navigation module configured to locate a first resource accessible to the particular class loader based on a resource location policy, the resource location policy determining a search order of a class loader hierarchy to locate the first resource among local resource sets identified for each class loader in the class loader hierarchy.

5. The apparatus of claim 4, wherein the resource location policy is provided by a configuration setting for the particular class loader.

6. The apparatus of claim 4, wherein the resource location policy is provided by a software call from developer source code.

7. The apparatus of claim 4, wherein the navigation module is further configured to locate a second resource accessible to the particular class loader based on a relative resource location policy, the relative resource location policy causing the navigation module to search for the second resource in the same location as the first resource.

8. The apparatus of claim 1, further comprising a traversal module configured to designate a parent class loader of the particular class loader as the particular class loader and repeatedly call the locator and association module until a local resource set is defined for a root class loader.

9. The apparatus of claim 1, further comprising a predefined second local resource set comprising resources accessible to a second class loader and not to ancestors of the second class loader, the apparatus further comprising a hierarchy module configured to define a hierarchical data structure comprising the local resource set and the second local resource set in substantially the same hierarchical relationship as the particular class loader and the second class loader.

10. The apparatus of claim 1, further comprising a storage module configured to preserve an association of the local resource set to the particular class loader.

11. A system for providing access to a set of resources available directly to a particular class loader, the system comprising:
a repository comprising a plurality of dynamically loadable resources;
a plurality of class loaders organized into a hierarchical relationship with a root class loader having a child class loader in a parent-child relationship, each child class loader having a single parent class loader, the hierarchical relationship configured such that each child generation is capable of accessing more dynamically loadable resources from the repository than an immediate parent generation of the child generation;
a utility module comprising a resource location module, the resource location module including,
a request handler configured to receive a resource identifier and a particular class loader;
a locator configured to identify a local resource set comprising resources available directly to the particular class loader, the resources corresponding to the resource identifier; and
an association module configured to associate the local resource set with the particular class loader.

12. The system of claim 11, wherein the locator further comprises,
a searcher configured to determine a first intermediate set comprising one or more resources accessible both to the particular class loader and to ancestors of the class loader, the searcher further configured to determine a second intermediate set comprising one or more resources accessible both to a parent class loader of the particular class loader and to ancestors of the parent class loader, the resources of the first intermediate set and the second intermediate set corresponding to the resource identifier; and
a comparison module configured to remove members of the second intermediate set found in the first intermediate set to define the local resource set.

13. The system of claim 11, wherein the association module further comprises,
a population module configured to populate a resource construct with the resource identifier, the particular class loader, and a resource location for each member of the local resource set; and
a registration module configured to register each resource construct in a repository, each entry in the repository having a key comprising a class loader and a resource identifier.

14. The system of claim 11, further comprising a navigation module configured to locate a first resource accessible to the particular class loader based on a resource location policy, the resource location policy determining a search order of a class loader hierarchy to locate the first resource among local resource sets identified for each class loader in the class loader hierarchy.

15. The system of claim 14, wherein the resource location policy is provided by a configuration setting for the particular class loader.

16. The system of claim 14, wherein the resource location policy is provided by a software call from developer source code.

17. The system of claim 14, wherein the navigation module is further configured to locate a second resource accessible to the particular class loader based on a relative resource location policy, the relative resource location policy causing the navigation module to search for the second resource in the same location as the first resource.

18. The system of claim 11, further comprising a traversal module configured to designate a parent class loader of the particular class loader as the particular class loader and repeatedly call the locator and association module until a local resource set is defined for the root class loader.

19. The system of claim 11, further comprising a predefined second local resource set comprising resources accessible to a second class loader and not to ancestors of the second class loader, the apparatus further comprising a hierarchy module configured to define a hierarchical data structure comprising the local resource set and the second local resource set in substantially the same hierarchical relationship as the particular class loader and the second class loader.

20. The system of claim 11, further comprising a storage module configured to preserve an association of the local resource set to the particular class loader.

21. A signal bearing medium tangibly embodying a program of machine-readable instructions executable by a digital processing apparatus to perform operations to provide access to a set of resources available directly to a particular class loader, the method comprising:
an operation to receive a resource identifier;
an operation to identify a local resource set comprising resources available directly to a particular class loader, the resources corresponding to the resource identifier; and
an operation to associate the local resource set with the particular class loader.

22. The signal bearing medium of claim 21, wherein the class loader comprises a child of one or more ancestor class loaders in a hierarchical relationship to the child, and wherein the an operation to identify further comprises,
an operation to determine a first intermediate set comprising one or more resources accessible both to the particular class loader and to ancestors of the class loader, the resources corresponding to the resource identifier;
an operation to determine a second intermediate set comprising one or more resources accessible to a parent class loader of the particular class loader and to ancestors of the parent class loader, the resources corresponding to the resource identifier; and
an operation to remove members of the second intermediate set found in the first intermediate set to define the local resource set.

23. The signal bearing medium of claim 21, wherein the operation to associate further comprises,
an operation to populate a resource construct with the resource identifier, the particular class loader, and a resource location for each member of the local resource set; and
an operation to register each resource construct in a repository, each entry in the repository having a key comprising a class loader and the resource identifier.

24. The signal bearing medium of claim 21, further comprising an operation to locate a first resource accessible to a particular class loader based on a resource location policy, the resource location policy determining a search order of a class loader hierarchy to locate the first resource among local resource sets identified for each class loader in the class loader hierarchy.

25. The signal bearing medium of claim 24, wherein the resource location policy is provided by a configuration setting for the particular class loader.

26. The signal bearing medium of claim 24, wherein the resource location policy is provided by a software call from developer source code.

27. The signal bearing medium of claim 24, further comprising an operation to locate a second resource accessible to a particular class loader based on a relative resource location policy, the relative resource location policy dictating a search for the second resource within the same location of the first resource.

28. The signal bearing medium of claim 21, further comprising,
an operation to designate a parent class loader of the particular class loader as the particular class loader; and
an operation to repeat the identifying and associating steps.

29. The signal bearing medium of claim 21, further comprising a predefined second local resource set comprising resources accessible to a second class loader and not to ancestors of the second class loader, the signal bearing medium further comprising an operation to define a hierarchical data structure comprising the local resource set and the second local resource set in substantially the same hierarchical relationship as the particular class loader and the second class loader.

30. The signal bearing medium of claim 21, further comprising an operation to preserve an association of the local resource set to the particular class loader.
